(19) United States
(12) Patent Application Publication
(10) Pub. No.: US 2002/0103028 A1
(43) Pub. Date: Aug. 1, 2002

(54) Networked casino gaming system and method of participation

(76) Inventors: Andrew W. Carter, Glen Ellyn, IL (US); J. Wayne Bennett, Las Vegas, NV (US)

Correspondence Address: WEISS & MOY PC, 4204 NORTH BROWN AVENUE, SCOTTSDALE, AZ, 85251, US

(21) Appl. No.: 09/772,312

(22) Filed: Jan. 29, 2001

(51) Int. Cl. G06F 17/00

(52) U.S. Cl. 463/42

(57) ABSTRACT

A networked gaming system and method permitting a person using a player computer to view a game being played live at a casino, and to wager on the outcome of the game. The player computer is in communication with a wager server, which in turn is receiving at least a video and preferably also an audio signal of the casino game from the casino. Wagering may be accomplished by a variety of payment methods, including direct payment from a player computer to the wagering server or through the use of a credit-type card, in which instance a financial institution server will also be part of the system and method. Preferably, an additional system component is provided, consisting of a casino-wagering server interface, which will be in communication with the casino and wagering server, will monitor the game being played and the wager, and which will determine the outcome of the wager and communicate that information to the wagering server for communication to the player computer.

### BACKGROUND OF THE INVENTION

1. Field of the Invention

This invention relates to casino gaming and, more specifically, to a networked gaming system and a method of participating in a networked gaming system.

2. Description of the Prior Art

Over the years, casino gaming has gained in popularity. Today, more people are interested in casino gaming than ever before. These people not only want to participate, but want to participate in the most convenient means possible. Players want to be able to take part in casino gaming at all hours of the day and from any location.

Until recently, the gambling landscape has been dominated by casinos, state-run lotteries, and sports books. The arrival of mass electronic communication, predominantly the Internet, has led to the emergence of electronic gambling. Electronic gambling permits players to play video game versions of real casino games, including blackjack, craps, roulette, video poker, baccarat, etc. From the player's perspective, the main advantage of a virtual casino is that casino games may be played without the need to travel to a casino. From the point of view of the casino, it can have numerous people participating in gaming without having to add floor space, tables, and personnel.

There are, however, a number of drawbacks to these existing virtual casino games. Chief among these negatives is a lack of realism—the players are, after all, only watching a computer-generated reproduction of an actual casino game—and the attendant reduction in gambling excitement. In addition, because play outcome is determined by a computer-generated random number, many players may be suspicious of the outcome, suspecting that the result could be “fixed.” These negatives can be solved—and a more exciting gambling experience provided—by a system and method that permits a player to witness an actual casino game and to place a wager on the outcome of that actual game.

Several attempts have been made at providing live gambling over networked systems such as the Internet. These attempts have been unsuccessful, however. First, previous attempts focused on allowing players to actually participate in games such as blackjack, where the actions of one player impact the outcome of wagers placed by other players participating in the game. For example, in a game of blackjack, the actions of the first player in deciding whether to take an additional card or not can change the outcome of the wagers of all players playing after the first player. The end result is that the number of players at a given table is, as a practical matter, limited to roughly the same number that would be able to play in an actual casino. This removes one of the primary advantages of increased player participation that preferably should characterize electronic gambling.

In addition, prior attempts at live casino gaming over the Internet have generally relied on making the home players active participants in the live game, instead of simply non-active participants. The complexity of giving a remote player control over the conduct of a casino game beyond the placing of a wager makes such systems impractical, limits the number of players than can take part electronically, and generally yields an unsatisfactory result.

A need therefore has existed for a networked gaming system and method that permits networked players to view and make wagers on games taking place in a casino, so as to create a virtual casino experience. A need further existed to allow the networked players to participate as wagerers only, and not as active participants in the game, so that many networked players can participate at a single time without in any way disrupting or even impacting on the conduct of the game at the casino. The present invention satisfies these needs and provides other, related, advantages.

### SUMMARY OF THE INVENTION

It is an object of the present invention to provide a networked gaming system and method that permits networked players to view and make wagers on games taking place in a casino, and thereby to create a virtual casino experience.

It is a further object of the present invention to provide a networked gaming system and method that allows networked players to participate remotely in a live casino game as wagerers only, and not as active participants in the game, so that many networked players can participate at a single time without in any way disrupting or even impacting on the conduct of the game at the casino.

### BRIEF DESCRIPTION OF THE PREFERRED EMBODIMENTS

In accordance with one embodiment of the invention a method for participating in a networked gaming system is disclosed. The method comprises the steps of: providing a live casino game in a casino; providing a wagering server in communication with the casino; providing at least one player computer in communication with the wagering server; transmitting a video image of the live casino game from the casino to the wagering server; transmitting the video image of the live casino game from the wagering server to the player computer; obtaining funds authorization for placing a wager through the player computer on an outcome of the live casino game; establishing a player account at the wagering server; placing the wager on the outcome of the live casino game; playing the live casino game; and one of crediting and debiting the player account based on the outcome of the live casino game.

In accordance with another embodiment of the present invention, a method for participating in a networked gaming system is disclosed. The method comprises the steps of: providing a live casino game in a casino; providing a wagering server in communication with the casino; providing a casino-wagering server interface wherein the casino-wagering server interface is in communication with each of the casino and the wagering server; providing at least one player computer in communication with the wagering server; transmitting a video image of the live casino game from the casino to each of the wagering server and the casino-wagering service interface; transmitting the video image of the live casino game from the wagering server to the player computer; obtaining funds authorization for placing a wager through the player computer on an outcome of the live casino game; establishing a player account at the wagering server; placing the wager on the outcome of the live casino game; playing the live casino game; the casino-wagering server interface determining the outcome of the live casino game; the casino-wagering server interface communicating the outcome of the live casino game to the wagering server; and one of crediting and debiting the player account based on the outcome of the live casino game.

In accordance with another embodiment of the present invention, a networked gaming system is disclosed. The networked gaming system comprises, in combination: a casino in which casino games are played; a wagering server in video communication with the casino; and a casino-wagering server interface wherein the casino-wagering server interface is in communication with each of the casino and the wagering server.

### BRIEF DESCRIPTION OF THE DRAWINGS

FIG. 1 is a schematic of the network gaming system of the present invention.

FIG. 2 is a flowchart depicting the operation of the networked gaming system of FIG. 1.

### DETAILED DESCRIPTION OF THE PREFERRED EMBODIMENT

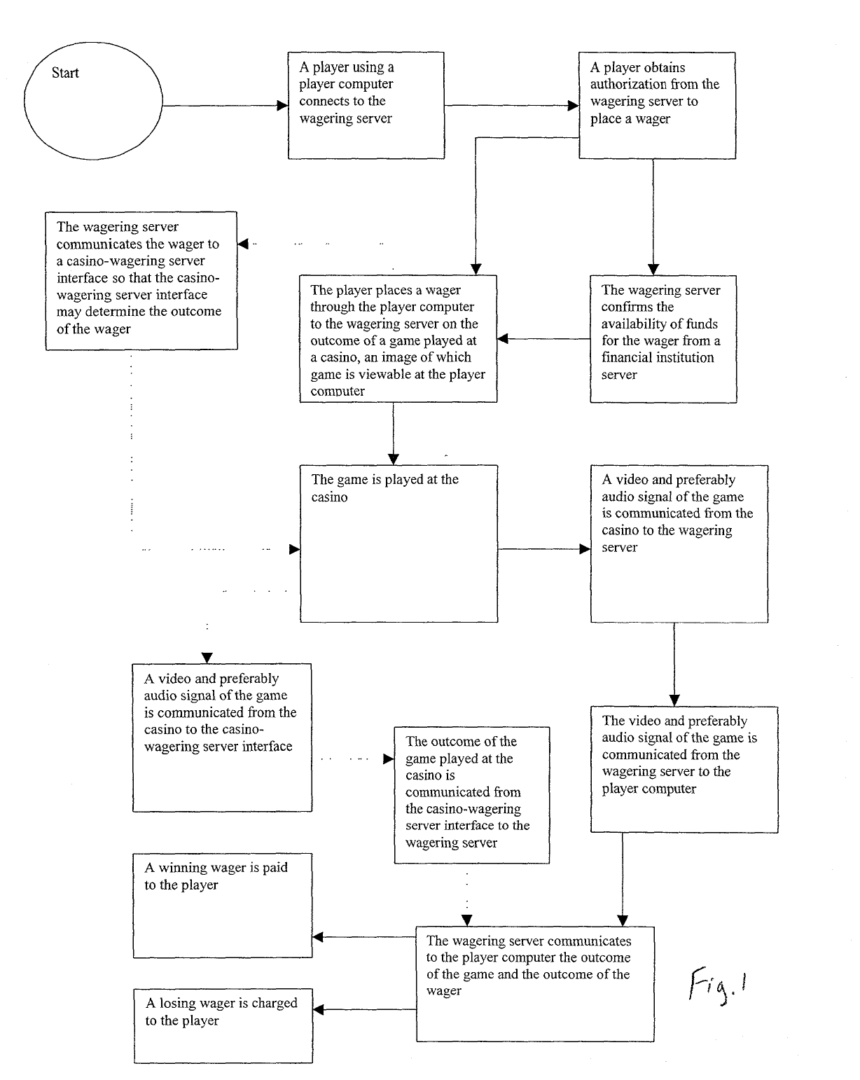

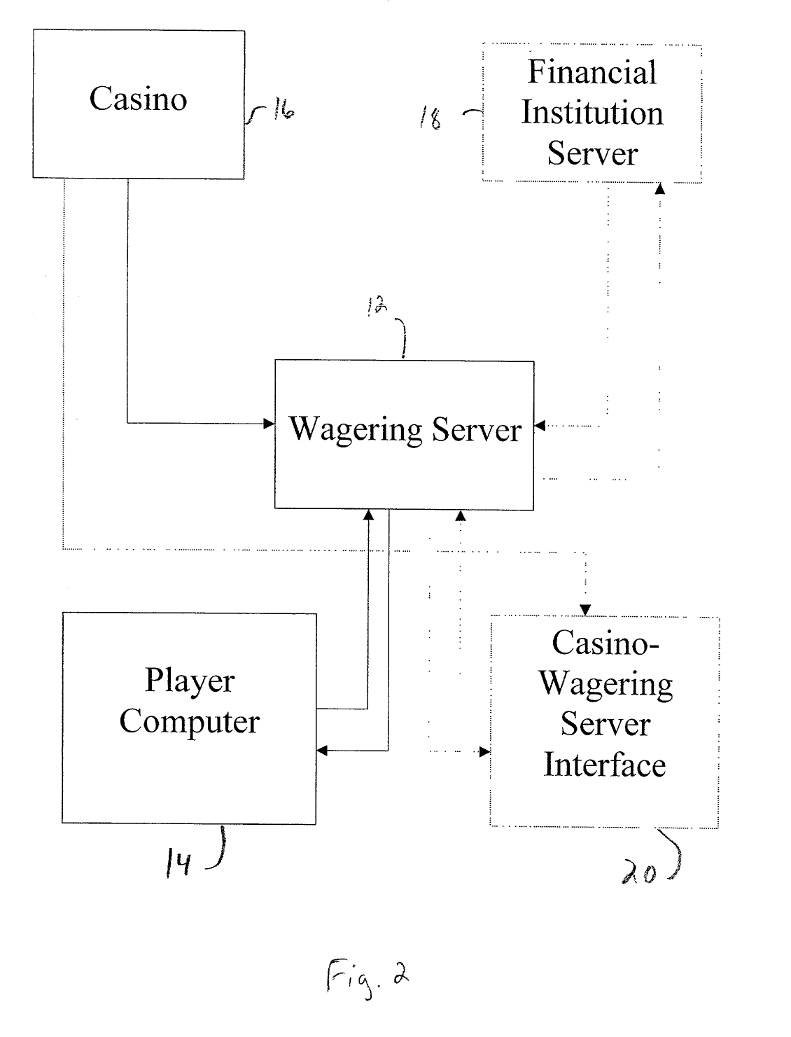

Referring to FIGS. 1-2, a networked gaming system 10 and method of operation is shown. The networked gaming system 10 comprises, in its most basic form, a wagering server 12, player computer 14, and casino 16. The wagering server 12 is the main control of the system 10. The wagering server 12 is used to authorize participation by a player operating a player computer 14, receive a video and preferably audio signal from a casino 16, transmit that signal to the player computer 14, accept wagering instructions from the player computer 14, determine the outcome of player wagers, and deposit funds into and withdraw funds from player accounts.

The networked gaming system 10 preferably comprises two additional components—a financial institution 18 and a casino-wagering server interface 20. (Dashed lines are used for these two components and the connections therewith to illustrate that they are not essential to the basic configuration of the networked gaming system 10.) Both the financial institution 18 and casino-wagering server interface 20 are connected to the wagering server 12. The financial institution 18, which may also be connected to the player computer 14, can be the source of funds used by a player, which funds are deposited into a player account at the wagering server 12. The player would then play against the deposited funds. When finished playing, and assuming funds deposited by a financial institution 18 remained in a player account at the wagering server 12, the player would have the option of leaving those funds in the player's account at the wagering server 12, or “cashing out,” in which case the funds would be returned from the wagering server 12 to the financial institution 18. Because funds would not need constantly to be drawn from the financial institution 18 to pay for each wager, it is not necessary for the wagering server 12 and financial institution 18 to remain in constant contact, and funds can instead be batch processed as between the two.

The casino-wagering server interface 20 receives the video and preferably audio signal from the casino 16, receives the wagering instructions from the wagering server 12, and reports the outcome of the wagers back to the wagering server 12.

Addressing the individual components and their interface in more detail, the wagering server 12 is basically a computer or computer-like system. It will preferably have a computer base unit or the like housing a motherboard having a Central Processing Unit (CPU) for processing data, a memory and hard drive for storing data; and a communication port for transferring data within the system 10. An input device such as a keyboard and/or a mouse is coupled to the computer base unit for entering data. Because the wagering server will be receiving a video and preferably audio signal from the casino 16, it will have coupled to the computer base unit a video display and speakers.

The gaming system 10 will further have one and preferably a plurality of player computers 14. The number of player computers 14 is dependent on the size and capacity of the wagering server 12. Each player computer 14 may take on several different forms depending on how the gaming system 10 is implemented. Generally, each player computer 14 will have a monitor which is coupled to a computer base unit. The monitor is used for visually displaying information, including the video signal originating from the casino 16. One or more input devices such as a keyboard, a mouse, or a stylus pen are also coupled to the computer base unit. The input devices are used to input information regarding the player and his wager into the player computer 14. All of these devices are coupled to a motherboard inside the computer base unit. The motherboard will generally have a CPU, memory, and a hard drive.

Each player computer 14 will be coupled to the wagering server 12 via a communication port. The communication port may be a modem, a network card or something of a similar nature. The communication port is used to transfer information across a communications line or in a wireless manner to and from the player computer 14 and the wagering server 12. The communication lines may be a phone line, DSL line, ISDN line, or the like. The player computer 14 may further have speakers which are also coupled to the computer base unit. The speakers would be used to hear an audio signal from the wagering server 12, including an audio signal originating from the casino 16 and re-transmitted by the wagering server 12.

The wagering server 12 is preferably also coupled to one or more financial institution servers 18. Each financial institution server 18 would be a source of player funds, to be placed in a player account at the wagering server 12. The financial institution server 18 will also receive player funds from the wagering server 12 in those instances where a player who has been wagering with funds from the financial institution server 18 “cashes out.” Each financial institution server 18 is coupled to the wagering server 12 via communication lines or in a wireless manner. The communication lines may be a phone line, DSL line, ISDN line, or the like.

It would also be possible for the networked gaming system 10 of the present invention to operate without a separate financial institution server 18, with the wagering server 12 itself acting as the “bank” for player wagers.

The networked gaming system 10 may take on several different forms. Preferably, the networked gaming system 10 is a remote system wherein the casino 16, wagering server 12, and player computer 14 are remote from one or both of the others—perhaps in two or more different countries. For example, a casino 16 could be located in the United States, with the wagering server 12 and one or more player computers 14 in Europe. Or, as an additional example, the casino 16 could be located in the United States, the wagering server 12 in Europe, and one or more player computers 14 in Canada. In this regard, player computers 14 may be located in player residences, or some of or all of the player computers 14 may be located in gaming establishments.

Statement of Operation

In operation, each player must receive authorization prior to making a wager. Authorization may take on several different forms. Preferably, a player obtains authorization from the player computer 14, registering with the wagering server 12 and providing whatever information is required. With respect to the provision of money for wagering, this may be provided in a number of different ways. A player could provide through the player computer 14 credit card information to the wagering server 12. The wagering server 12 will then establish a line of communication with the player's financial institution server 18. The wagering server 12 will query the player's financial institution server 18. The financial institution server 18 will then indicate whether the player has sufficient funds in his/her account to support the wager. If the player's account has sufficient funds, the financial institution server 18 will send a message to the wagering server 12 indicating such, and these funds will then be deposited into a player account—to be wagered against. If the player does not have sufficient funds, the player's financial institution server 18 will tell the wagering server 12 that the player does not have the proper amount of funds. The wagering server 12 will then send an insufficient funds message which will then appear on the screen where the player has entered the information (i.e., on the player computer 14). The player may then be asked to reenter the financial information. The whole process then repeats itself. After several unsuccessful attempts, the wagering server 12 will lock the player out so to prevent any fraudulent transaction.

Where a financial institution server 18 is involved, it is preferable that contact between the financial institution server 18 and the wagering server 12 be non-continuous, with communications regarding player funds (e.g., placing a wager, cashing out) taking place through a batch process as necessary. Thus, after the funds are initially provided by the financial institution server 18 to the wagering server 12 and into a player account, communication between these two servers can be interrupted. The player can make wagers with the wagering server 12 against his or her player account. When finished wagering, if there are still funds in the player account, the player has the option of leaving those funds in the account for future wagering activity, or “cashing out,” in which case the wagering server 12 will transmit the remaining funds to the financial institution server 18.

More direct payment methods would also be possible. For example, a player may insert a certain amount of money in a money reader which may be part of each player computer 14. (This method would be particularly appropriate where the player computer 14 is located in a gaming establishment, which will have control over the money reader.) The player may then make wagers based on the amount of money inserted into the money reader or will be given an appropriate number of credits.

Local authorization at the player computer 14 may also be done via a smart card. A player may pre-purchase a smart card with a set amount of credits. The player would then insert the smart card into a card reader on a desired player computer 14. The smart card would be read by the player computer 14. The smart card information would be transferred to the wagering server 12 to see if any credits still remain on the smart card. If credits remain on the smart card, the player would be authorized to place a wager(s) based on the amount of credits on the smart card.

It is still further possible for a player to wager for non-cash stakes—such as credits, points or the like. These stakes could later be converted into products, prizes, services, or other rewards.

The game upon which the player operating a player computer 14 seeks to place a wager is a game that is played at the casino 16. A video image of that game and preferably the accompanying audio signal is transmitted from the casino 16 to the wagering server 12, and from the wagering server 12 to the player computer 14. Preferably, the player will only place wagers on a game in which there is no player interaction following the placing of the wager. Examples of such games include craps, roulette, and baccarat. (Examples of games requiring interaction after the placing of the bet would include 21 and poker.) By transmitting the image of a game from a casino 16 to a wagering server 12, and by having the wagering server 12 rather than the casino 16 accept wagers from a player, a casino is essentially separated into two parts—a gaming portion represented by the casino 16 where games of chance are played and may be wagered upon, and a wagering portion represented by the wagering server 12, where wagers on the games of chance may be placed. Among other benefits to this arrangement is that it can provide low-cost gaming. Thus, a wagering server 12 can provide a casino gaming experience to a player operating a player computer 14 without the need to actual operate a casino.

In the preferred embodiment, a casino-wagering server interface 20 is part of the system 10. In this embodiment, the casino-wagering server interface 20 will receive the signal from the casino 16 (which signal is video and preferably audio as well) and will communicate to the wagering server 12 the outcome of a game played at the casino 16. The wagering server 12 may communicate information regarding wagers placed by a player through a player computer 14, so that the casino-wagering server interface 20 can also determine the outcome of the wager and communicate that result to the wagering server 12. The involvement of the casino-wagering server interface 20 is shown in dashed lines in FIG. 2, to highlight that it is an optional part of the basic system 10.

Payment of a winning wager can happen in several different ways. For example, the winning player computer 14 may be given a predetermined number of credits for winning. The player may use those credits for making additional wagers. If the player wishes to cash out, the credits will be translated to a cash value by the wagering server 12. The wagering server 12 will then transfer this information to the player's financial institution server 18 which will credit the player's account with the appropriate amount of money. Alternatively, the winning jackpot could be directly credited to the winning player's financial institution. Still further, funds could be sent from the wagering server 12 to the player in check form via mail, courier, etc.

While the invention has been particularly shown and described with reference to preferred embodiments thereof, it will be understood by those skilled in the art that the foregoing and other changes in form and details may be made therein without departing from the spirit and scope of the invention.

We claim:

1. A method for participating in a networked gaming system comprising the steps of:
providing a live casino game in a casino;
providing a wagering server in communication with said casino;
providing at least one player computer in communication with said wagering server;
transmitting a video image of said live casino game from said casino to said wagering server;
transmitting said video image of said live casino game from said wagering server to said player computer;
obtaining funds authorization for placing a wager through said player computer on an outcome of said live casino game;
establishing a player account at said wagering server;
placing said wager on said outcome of said live casino game;
playing said live casino game; and
one of crediting and debiting said player account based on said outcome of said live casino game.

2. The method of claim 1 further comprising the step of providing a financial institution server in communication with said wagering server.

3. The method of claim 2 further comprising the step of providing player funds from said financial institution server to said wagering server.

4. The method of claim 3 further comprising the step of transmitting an audio signal from said live casino game in said casino to said wagering server.

5. The method of claim 1 further comprising the step of transmitting an audio signal from said live casino game in said casino to said wagering server.

6. The method of claim 1 wherein said step of obtaining funds authorization comprises the step of providing credit card information from said player computer to said wagering server.

7. The method of claim 1 wherein said step of obtaining funds authorization comprises the step of providing direct payment from said player computer to said wagering server.

8. The method of claim 1 wherein said funds that are authorized are a cash alternative.

9. The method of claim 2 further comprising the step of cashing out.

10. The method of claim 9 wherein said step of cashing out further comprises the step of transmitting cashed out funds from said wagering server to said financial institution server.

11. A method for participating in a networked gaming system comprising the steps of:
providing a live casino game in a casino;
providing a wagering server in communication with said casino;
providing a casino-wagering server interface wherein said casino-wagering server interface is in communication with each of said casino and said wagering server;
providing at least one player computer in communication with said wagering server;
transmitting a video image of said live casino game from said casino to each of said wagering server and said casino-wagering service interface;
transmitting said video image of said live casino game from said wagering server to said player computer;
obtaining funds authorization for placing a wager through said player computer on an outcome of said live casino game;
establishing a player account at said wagering server;
placing said wager on said outcome of said live casino game;
playing said live casino game;
said casino-wagering server interface determining said outcome of said live casino game;
said casino-wagering server interface communicating said outcome of said live casino game to said wagering server; and
one of crediting and debiting said player account based on said outcome of said live casino game.

12. The method of claim 11 further comprising the step of providing a financial institution server in communication with said wagering server.

13. The method of claim 12 further comprising the step of providing player funds from said financial institution server to said wagering server.

14. The method of claim 11 further comprising the step of transmitting an audio signal from said live casino game in said casino to said wagering server.

15. The method of claim 11 wherein said step of obtaining funds authorization comprises the step of providing credit card information from said player computer to said wagering server.

16. The method of claim 11 wherein said step of obtaining funds authorization comprises the step of providing direct payment from said player computer to said wagering server.

17. The method of claim 11 wherein said funds that are authorized are a cash alternative.

18. The method of claim 11 further comprising the step of cashing out.

19. The method of claim 18 wherein said step of cashing out further comprises the step of transmitting cashed out funds from said wagering server to said financial institution server.

20. A networked gaming system comprising, in combination:
a casino in which casino games are played;
a wagering server in video communication with said casino; and
a casino-wagering server interface wherein said casino-wagering server interface is in communication with each of said casino and said wagering server.
